(19) United States
(12) Patent Application Publication
(10) Pub. No.: US 2026/0000922 A1
(43) Pub. Date: Jan. 1, 2026

(54) Fire Blanket

(71) Applicants: Adam Palmer, Miami Beach, FL (US); David Seun Olubodun, Miami Beach, FL (US)

(72) Inventors: Adam Palmer, Miami Beach, FL (US); David Seun Olubodun, Miami Beach, FL (US)

(21) Appl. No.: 18/759,808

(22) Filed: Jun. 29, 2024

(51) Int. Cl. A62C 2/04; A62C 3/16

(52) U.S. Cl. CPC A62C 2/04; A62C 3/16

(57) ABSTRACT

According to an aspect of the present invention disclosed herein, there is provided a fire blanket, comprising: a blanket made of fire proof fabric; a plurality of straps at the edge of the blanket; weighted chain sewn into fire proof piping along the edge of the blanket; and a handle at the center of the blanket.

### BACKGROUND

The present invention is in the technical field fire blankets and in particular straps and handles on fire blankets. Fire blankets are designed to be draped over fire so that less oxygen can reach a fire and it is smothered. Fire blankets are in particular suitable for extinguishing relatively small fires. In case of fire, the fire blankets are to be used rapidly in order to prevent a fire from causing more damage.

Relevant prior art includes U.S. Pat. No. 8,272,450 which discloses a fire blanket comprising: a poorly flammable or inflammable, substantially flexible blanket material; and two relatively rigid handles attached to the blanket material, wherein the blanket material is folded into a storage position, and wherein the two relatively rigid handles project at least partly outside the blanket material folded into the storage position, so that the two relatively rigid handles can be grasped by at least one hand, and wherein the handles are connected to the fire blanket material in a manner such that hands grasping the handles are well protected from a fire, wherein the handles are fastened to the blanket material at a distance from the top edge of the blanket material, the distance from the edge being more than 5 cm and no more than half a height of the blanket material, wherein the blanket material in the storage position is folded up such that when the handles are moved apart, the fire blanket takes up an extinguishing position, wherein the blanket has a relatively small front flap and a relatively large screening flap, wherein the handles comprise distancing elements fastened to the blanket material such that the front flap and the screening flap extend to surround the fire while a blanket part is stretched to a greater or smaller extent and/or approximately horizontally above the fire.

U.S. Pat. No. 5,083,617 discloses multi-layered fire extinguishing blanket including a fire-proof blanket of fire-resistant, fabric layer having a peripherally attached, non-porous, laminated aluminum layer on one side, creating insulating air pockets between the two, and two handles on the fabric backside of the blanket for manually grasping the blanket prior to placing it over a fire aluminum side down. The handles are mounted at positions spaced substantially below the top edge of the blanket, so that a portion of the blanket between the handles and the top edges, which is of a material having little if any rigidity, is allowed to drape back over, covering and protecting the hands, the handles also providing greater control of the blanket for more effective operation. A number of peripherally located, spaced magnets keep the fireproof blanket secured over the fire in a metallic environment and give sufficient, strategically located, peripherally spaced weight to the blanket, providing for a good throw and inherent opening characteristic to the blanket, when thrown over the fire. The aluminum layer serves as a heat sink and barrier to oil and grease, and as a water entrapping barrier when the fabric side is saturated with water in using the blanket in reverse fashion on a super hot fire. A set of supplemental handle straps is located at the top of the blanket stored in slots for pull-up/out and over use, when the blanket is to be positioned in reversed fashion (fabric side down) over the fire.

However, prior art fire blankets are lacking in effectiveness for fires affecting electronic devices.

### SUMMARY OF INVENTION

Therefore, the present invention provides a fire blanket which is particularly suited for electronic device fires, such as fires involving lithium ion batteries.

According to an aspect of the present invention disclosed herein, there is provided a fire blanket, comprising: a blanket made of fire proof fabric; a plurality of straps at the edge of the blanket; weighted chain sewn into fire proof piping along the edge of the blanket; and a handle at the center of the blanket.

According to another aspect of the present invention disclosed herein, there is provided a method of using a fire blanket for suppressing an electronic device fire, comprising: using a handle at the center of the fire blanket to drape the fire blanket over an electronic device on fire; using weighted chains at the edge of the fire blanket to hold down the edges; waiting for the electronic device on fire to cool; and tying up the burned electronic device using straps provided at corners of the fire blanket.

### BRIEF DESCRIPTION OF THE DRAWINGS

FIG. 1 is an illustration of the fire blanket according to an embodiment of the present invention.

FIG. 2 is an illustration of the utilization of the fire blanket according to an embodiment of the present invention.

### DETAILED DESCRIPTION

Embodiments of the present invention will be described with reference to the following drawings.

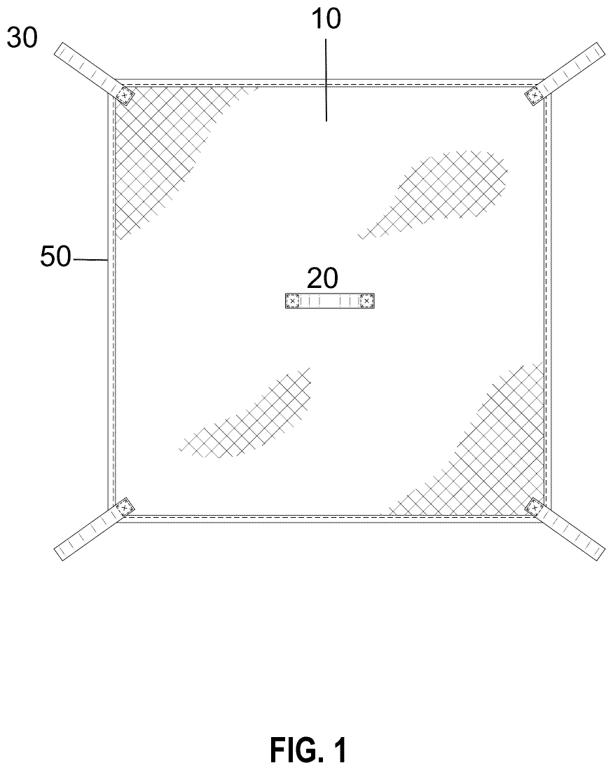

FIG. 1 is an illustration of the fire blanket according to an embodiment of the present invention.

Fire blanket 10 is manufactured from fire-resistant, i.e. poorly flammable or inflammable, material, which is flexible. A known material for that purpose is, for instance, woven glass fiber, with or without a fire-resistant coating, but several other suitable materials are known and can be used in embodiments of the present invention.

Handle 20 is provided in the middle of the fire blanket 10. The handle in the middle is meant to allow the user of the blanket to readjust on the burning device so the user does not need risk being burned by direct contact with the fire blanket.

The straps 30 on the corners are meant to tie up the remains of a burned electronic device similar to a trash bag which a user can cinch it up and tie it so it forms a sack to safely throw out the remains of the burned electronic device after it cools down.

Weighted chain 50 is sewn into fire proof piping along the edge of the blanket and will keep the blanket weighted to the surface on which the electronic device rests, and therefore keep the smoke and all the burning electronic components inside.

The straps 30 and the handle 20 are also made from a fire proof material. Synthetic fibers comprise most of the top choices for fire-resistant fabrics.

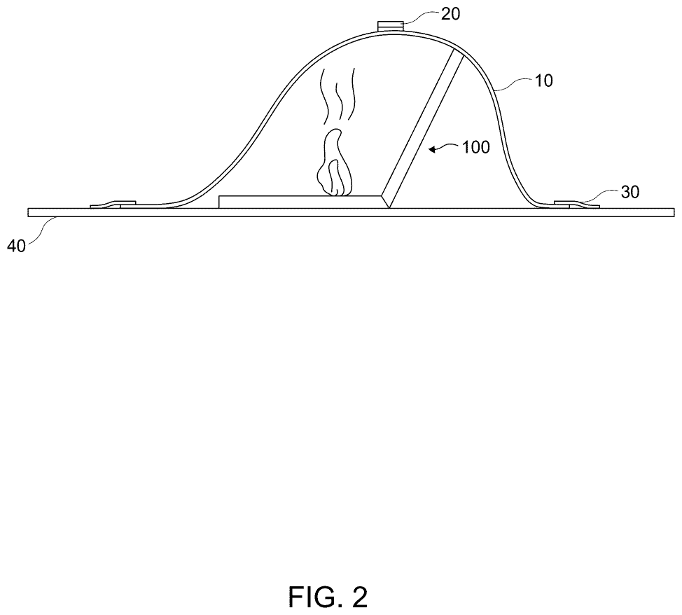

FIG. 2 is an illustration of the utilization of the fire blanket according to an embodiment of the present invention.

The burning electronic device 100 rests on a surface 40 which could be a floor or a table. The user uses the handle 20 at the center of the fire blanket 10 to drape the fire blanket over the electronic device 100 on fire, which is held down the edges using weighted chains at the edge of the fire blanket to hold it.

The user can then wait for the electronic device on fire to cool and then tie up the burned electronic device using straps 30 provided at corners of the fire blanket.

The illustrations of embodiments described herein are intended to provide a general understanding of the structure of various embodiments, and they are not intended to serve as a complete description of all the elements and features of apparatus and systems that might make use of the structures described herein. Other embodiments may be utilized and derived therefrom, such that structural and logical substitutions and changes may be made without departing from the scope of this disclosure.

Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description. Therefore, it is intended that the disclosure not be limited to the particular embodiment(s) disclosed.

Figures are also merely representational and may not be drawn to scale. Certain proportions thereof may be exaggerated, while others may be minimized. Accordingly, the specification and drawings are to be regarded in an illustrative rather than a restrictive sense.

What is claimed is:

1. A fire blanket, comprising:
a blanket made of fire proof fabric;
a plurality of straps at the edge of the blanket;
weighted chain sewn into fire proof piping along the edge of the blanket; and
a handle at the center of the blanket.

2. The fire blanket of claim 1, wherein the fire blanket is rectangular in shape.

3. The fire blanket of claim 2, wherein the fire blanket is square in shape.

4. The fire blanket of claim 1, wherein the fire blanket is made of fiberglass.

5. The fire blanket of claim 1, wherein the number of straps at the edge of the blanket is four.

6. The fire blanket of claim 1, wherein the fire proof fabric is colored.

7. The fire blanket of claim 3, wherein the sides of the square are approximately 30 inches long.

8. The fire blanket of claim 5, wherein the straps extend diagonally from the corners.

9. A method of using a fire blanket for suppressing an electronic device fire, comprising:
using a handle at the center of the fire blanket to drape the fire blanket over an electronic device on fire; and
providing weighted chains at the edge of the fire blanket to hold down the edges.

10. The method of using a fire blanket for suppressing an electronic device fire of claim 9, further comprising:
waiting for the electronic device on fire to cool; and
tying up the burned electronic device using straps provided at corners of the fire blanket.
